(19) United States
(12) Patent Application Publication
(10) Pub. No.: US 2024/0251034 A1
(43) Pub. Date: Jul. 25, 2024

(54) METHOD FOR PROCESSING A TELEPHONE CALL IN A COMMUNICATION NETWORK, METHOD FOR TRANSMITTING, METHOD FOR RECEIVING SUCH A CALL, CORRESPONDING DEVICES, SYSTEM AND COMPUTER PROGRAMS

(71) Applicant: Orange, Issy-Les-Moulineaux (FR)

(72) Inventors: Paul BEARDOW, Chatillon Cedex (FR); Frank DERVILLE, Chatillon Cedex (FR)

(21) Appl. No.: 18/566,036

(22) PCT Filed: May 30, 2022
(86) PCT No.: PCT/FR2022/051007

§ 371 Date: Nov. 30, 2023

(30) Foreign Application Priority Data
May 31, 2021 (FR) FR2105725

(51) Int. Cl. H04M 3/42

(52) U.S. Cl. CPC H04M 3/42042

(57) ABSTRACT

A method for processing a call set-up request message transmitted by a calling terminal to a called terminal in a communication network, the network including an item of communication equipment configured to receive the message. The method is implemented at the item of communication equipment and includes: updating an information field of the message by inserting additional caller identification information obtained from at least one first data table; and transmitting the updated message to the called terminal.

### CROSS-REFERENCE TO RELATED APPLICATIONS

This application is filed under 35 U.S.C. § 371 as the U.S. National Phase of Application No. PCT/FR2022/051007 entitled “METHOD FOR HANDLING A TELEPHONE CALL IN A COMMUNICATION NETWORK, TRANSMISSION METHOD, METHOD FOR RECEIVING SUCH A CALL, AND CORRESPONDING DEVICES, SYSTEM AND COMPUTER PROGRAMS” and filed May 30, 2022, and which claims priority to FR 2105725 filed May 31, 2021, each of which is incorporated by reference in its entirety.

### BACKGROUND

### Field

The field of the development is that of a communication network configured to route calls, for example in voice over IP. The development relates in particular to the enrichment of such calls with caller identity information.

### Description of the Related Art

Many telephone calls are left unanswered when the called user does not recognise the caller's telephone number. In fact, sales marketing no longer involves the use of easily recognisable special numbers, but instead involves any type of fixed-line or mobile telephone number, and the called user often prefers not to answer to avoid being disturbed.

This means that the called user may miss legitimate and important calls, for example from a doctor, hospital, school or deliverer. Even worse, the user's terminal may block the telephone number of the caller if the latter calls again.

There is already a solution to try solving this problem, which involves installing a specific software application on the terminal of the called user. Upon reception of a call from an unknown caller telephone number, and in particular one that is not recorded in the contacts of the called user, the application in question queries one or more databases accessible on the Internet to find out the identity of the caller, the reasons for the call and any additional information to be presented to the called user, such as the name of the company, a link to their website, etc.

A first disadvantage of this solution is that it introduces a latency in processing the received call. A second disadvantage is that it only works if the caller's identity is stored in the database queried by the application and if the database is accessible at the time of the call. A third disadvantage is that several databases coexist without common rules for storing or formatting the identity information of the callers. As a result, companies wishing to register with such databases have to go through numerous registration procedures, with no guarantee of success.

There is therefore a need for a better, more efficient solution.

The development improves the situation.

### SUMMARY

The development responds to this need by proposing a method for processing a call set-up request message transmitted by a calling terminal to a called terminal in a communication network, said network comprising an item of communication equipment configured to receive said message.

Said method is implemented at the level of said item of communication equipment and comprises:
updating an information field of said message by inserting additional caller identification information obtained from at least one first data table; and
transmitting the updated message to the called terminal.

The development proposes a completely new and inventive approach to processing a call, which comprises enriching the call with additional caller identification information stored in the communication network and therefore previously verified. In this way, the called party benefits from verified identification information upon reception of the call on their terminal, without latency. Better informed, the called user is therefore more inclined to answer the call. As a result, the development helps to reduce the number of unanswered calls due to a lack of information about the caller.

Advantageously, the call is transmitted in voice over IP and the updated information field is a field of a header of said call set-up request message. For example, in SIP, this is the “Display Name” field in the “From and P-asserted-Identity” header of the SIP INVITE message.

For example, said additional caller identification information obtained from the first table belongs to a group comprising at least:
a caller name;
information relating to an image or a video associated with the caller.

Information relating to an image or video associated with the caller may include a link to this file. For example, the file in question includes a company logo and/or a photograph of the caller and/or an advertisement of the company.

Advantageously, the method also comprises querying the first data table, for example called the caller identity table, on the basis of a caller telephone number extracted from said message.

According to one aspect of the development, when no additional information is obtained from the first data table, the update comprises inserting reputation information obtained from a second data table into the call set-up request message.

For example, an item of reputation information indicates a type of caller among the following possible values: sales marketer (“TELE”), fraudulent (“SPAM”) or legitimate (“OK”).

Advantageously, the method also comprises querying the second data table, for example known as caller reputation table, on the basis of a caller telephone number extracted from said message.

According to another aspect of the development, the method further comprises:
receiving a request to add additional information associated with the caller's telephone number from the calling terminal, said request comprising said telephone number and said information; and
storing said information in the first data table in association with said telephone number.

In an initial phase, this information is additional caller identification information. Advantageously, in a subsequent phase, it may be additional information relating to a call context. For example, these items of information can indicate a purpose of the call, a level of urgency, an emotion from the caller, etc. They help to enrich the presentation of the call to the called party further.

Advantageously, the method also comprises the prior verification of an authorisation from the calling terminal to update the first data table, the addition of the information received in the table being conditioned by this verification. Optionally, it also includes sending a registration confirmation message to the calling terminal.

According to yet another aspect of the development, the method comprises encoding at least one of said items of information obtained in the form of a code comprising a sequence of text-type characters surrounded by two occurrences of a key-type character, said key-type character being associated with an item of predetermined call context information.

For example, the key character is an asterisk “**” associated with an item of caller reputation information. In another example, the key character “%%” is used to surround a link to an image or video file associated with the caller.

The development also relates to a device for processing a call set-up request message transmitted by a calling terminal to a called terminal in a communication network, said network comprising an item of communication equipment configured to receive said message. Said device is configured to implement at said item of communication equipment:
updating an information field of said message by inserting additional caller identification information obtained from at least one first data table; and
transmitting the updated message to the called terminal.

Advantageously, said device is configured to implement the steps of the processing method as described above. In combination, the treatment device has some or all of the features described throughout this document.

Advantageously, said device is included into an item of communication equipment in a communication network, configured to intercept a voice over IP call set-up request message transmitted by a calling terminal to a called terminal.

The item of communication equipment and the processing device have at least the same advantages as those provided by the above-mentioned processing method.

Correlatively, the development also relates to a method of transmitting a call set-up request message by a calling terminal to a called terminal in a communication network. Said method is implemented at the calling terminal and comprises, prior to transmission of said message:
transmitting a request to record additional caller identification information in a first data table stored in said communication network, in association with a caller telephone number, said additional caller identification information being intended to be used by an item of communication equipment configured to receive said call set-up request message, to enrich it at least using the information contained in said first table and to retransmit it to the called terminal.

For example, the calling terminal includes a dedicated software application configured to fill in such a first table, for example known as “caller identity table”, managed by the network operator.

Advantageously, it receives a confirmation of registration of said information from the item of communication equipment.

According to one aspect of the development, the method also comprises transmitting to the communication network a request to update the first data table, said update request comprising at least one item of call context information.

Call context information specifies, for example, a reason or purpose for the call, a level of urgency, an emotion of the caller, etc.

In this way, the identity table managed by the communication network is dynamically updated by the caller before one or more further messages are sent to one or more called terminals using information specific to the content of these calls.

The development also relates to a device for transmitting a call set-up request message by a calling terminal to a called terminal in a communication network. Said device is configured to implement at the calling terminal, prior to transmission of said message:
transmitting a request to record additional caller identification information in a first data table, stored in said communication network, in association with a caller telephone number, said additional caller identification information being intended to be used by an item of communication equipment configured to receive said call set-up request message, to enrich it at least using the information contained in said first table and to retransmit it to the called terminal.

Advantageously, said device is configured to implement the steps of the transmission method as described above. In combination, the transmitting device has some or all of the features described throughout this document.

Advantageously, said device is included into a user terminal configured to transmit a voice over IP call set-up request message to a calling terminal through a communication network.

The user terminal and the transmitting device have at least the same advantages as those provided by the above-mentioned transmitting method.

Correlatively, the development also relates to a method for receiving a call set-up request message by a called terminal transmitted by a calling terminal in a communication network. Said method is implemented at the called terminal and comprises, upon reception of said message:
extracting additional information relating to a user of the calling terminal from an information field of the received message; and
triggering at least one action comprising a notification of said information to a user of the called terminal during a presentation of the call.

According to the development, because the additional information relating to the caller is contained in the signalling of the message, the called terminal can use it directly to enrich the notification of the call.

Advantageously, the extracted additional information belongs to a group comprising at least:
additional caller identification information;
information relating to a context of the call;
caller reputation information.

Advantageously, the additional caller identification information comes from a first data table managed by the operator of the communication network of the caller and has been previously incorporated into the table on request of the caller, who has subscribed to a dedicated service.

For example, information relating to a context of the call comes from this first data table and was transmitted by the caller to the first table before transmitting the call. This possibility of dynamically modifying the additional information contained in the database enables a caller to enrich one or more calls intended for one or more customers to indicate a level of urgency of the call or a reason for the call (“are you available to talk?”) or an emotion associated with this call using one or more emoticons.

Finally, the reputation information advantageously comes from a second data table, also managed by the communication network operator, but which is not filled in from information provided by the callers themselves. For example, they indicate whether the caller is legitimate, fraudulent, a sales marketer, etc.

According to one aspect of the development, at least one of said additional items of information relating to the call is encoded in the form of a sequence of text-type characters surrounded by two occurrences of a key-type character, the receiving method comprises decoding said information, said decoding comprising the identification of said key-type character and the method comprises determining at least one notification action triggered at least depending on the identified key-type character.

For example, the key character “*” is used to surround a sequence of textual characters qualifying a reputation of the caller (SPAM for fraudulent, TELE for a sales marketer or OK for a legitimate caller). In another example, the key character “!” surrounds the name of the caller and indicates an urgent call. In yet another example, the key character “?” surrounds the caller's name and is meant to ask the called party if they are available to talk.

One advantage of such key characters is that they can be recognised by the called party's terminal which is configured to translate them into specific notifications (display, ringtone, vibration, etc.) that therefore take on a particular meaning for the called party. For example, displaying a caller name between “!” is translated by a display of the caller's name in flashing red, generally associated with the notion of urgency or with the emission of a pressing ringtone.

For example, identifying a sequence surrounded by the key character “*” triggers the display of a pop-up window indicating the type of call (sales marketing, fraudulent, legitimate).

For example, identifying a sequence surrounded by the key character “%” triggers the download of the image or video to the indicated link and its display on the screen of the called party's terminal.

The development also relates to a device for receiving a call set-up request message from a called terminal transmitted by a calling terminal in a communication network, characterised in that it is configured to implement at the called terminal and comprises, upon reception of said message:
extracting additional information relating to a user of the calling terminal from an information field of the received message; and
triggering at least one action comprising a notification of said information to a user of the called terminal during a presentation of the call.

Advantageously, said device is configured to implement the steps of the receiving method as described above. In combination, the receiving device has some or all of the features described throughout this document.

Advantageously, said receiving device is included into a user terminal configured to receive a voice over IP call set-up request message from a calling terminal through a communication network.

The user terminal and the receiving device have at least the same advantages as those provided by the above-mentioned receiving method.

Correlatively, the development also relates to a data table of a communication network, comprising records associating at least additional caller identification information with a telephone number of this caller.

For example, this data table is organised in the form of a database indexed by the telephone numbers of the callers. Advantageously, it includes information relating to a context of a call, added dynamically by the caller before transmitting this call into the network.

Correlatively, the development also relates to a system for managing a voice over IP call set-up request message by a calling terminal to a called terminal in a communication network, comprising the above-mentioned processing device, first data table, transmitting device and receiving device.

The development also relates to computer program products comprising program code instructions for implementing the methods as described previously, when they are executed by a processor.

A program can use any programming language, and can be in the form of source code, object code, or intermediate code between source code and object code, such as in a partially compiled form, or in any other desirable form.

The development also relates to a computer-readable storage medium on which is saved a computer program comprising program code instructions for implementing the steps of the methods according to the development as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or a SSD.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the above-mentioned display control method.

According to one embodiment, the present technique is implemented using software and/or hardware components. In this context, the term “module” may be used in this document to refer to a software component, a hardware component or a set of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or service, whether individually or in combination.

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

Each component of the system described above naturally implements its own software modules.

The various embodiments mentioned above can be combined with each other for the implementation of the present technique.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows an example of architecture of a system for processing a voice over IP call set-up request message in a communication network, according to the development;

FIG. 2 diagrammatically illustrates an example of architecture of an item of communication equipment of the communication network, said item of equipment incorporating a device for processing a call set-up request message according to one embodiment of the development and an example of a user terminal, incorporating a device for receiving a call set-up request message according to one embodiment of the development;

FIG. 3 describes in the form of a flowchart the steps of a method for processing a call set-up request message by the item of communication equipment, according to one embodiment of the development;

FIG. 4 describes in the form of a flowchart the steps of a method for transmitting a call set-up request message by the calling terminal, according to one embodiment of the development;

FIG. 5 describes in the form of a flowchart the steps of a method for receiving a call set-up request message by the called terminal, according to one embodiment of the development;

FIG. 6A, FIG. 6B, FIG. 6C show examples of displays of additional caller identification information on the called terminal according to the development;

FIG. 7 describes in the form of a flow diagram the exchanges between a calling user terminal, the item of communication equipment and a caller user terminal according to one embodiment of the development;

FIG. 8 describes an example of hardware structure of a device for processing a call set-up request message according to the development;

FIG. 9 describes an example of hardware structure of a device for transmitting a call set-up request message according to the development; and

FIG. 10 describes an example of hardware structure of a device for receiving a call set-up request message according to the development.

### DETAILED DESCRIPTION OF CERTAIN ILLUSTRATIVE EMBODIMENTS

The development relates to the processing of a call transmitted in voice over IP in a communication network by a calling terminal to a called terminal.

The general principle of the development is based on the enrichment, at the communication network level, of the call signalling message using additional caller identification information stored in at least one database managed by the communication network operator. This information is notified by the called terminal during the presentation of the incoming call to its user. In this way, the called party benefits from reliable additional information about the caller's identity without latency, enabling them to decide whether or not to accept the call with full knowledge of the facts.

The development has a particularly interesting application for professionals who want their calls to customers or suppliers to be successful.

It applies to the processing of voice over IP telephone calls by a fixed-line or mobile communication network, for example using VOLTE (Voice over Long Term Evolution), ViLTE (Video over Long Term Evolution) or VoIP (Voice over Internet Protocol) technology. These different technologies generally rely on a signalling protocol, such as SIP (Signalling Internet Protocol), to establish and manage a telephone communication session.

Naturally, the development is not limited to this protocol and is applicable to any other protocol that enables VOIP call signalling. However, in the remainder of the description, the examples presented will implement this signalling protocol.

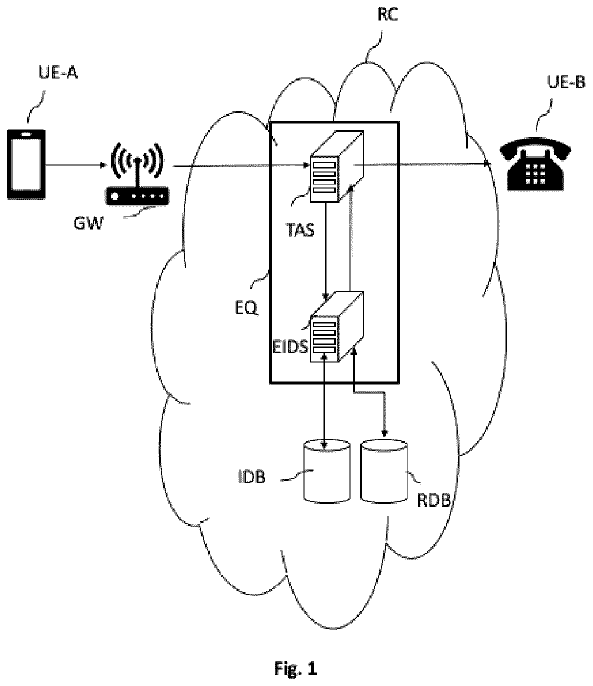

In relation to FIG. 1, an example of the architecture of a system 10 for processing a voice over IP call set-up request message in a communication network RC according to one embodiment of the development is now presented. In this example, the communication network RC of an operator has been represented schematically as a single entity, without showing its different access networks for simplicity. It is assumed that this communication network RC implements at least one of the voice over IP technologies discussed above. In this example, a first item of terminal equipment UE-A connects to the communication network RC via a fixed-line access network (not shown) of the ADSL or fibre type. The first item of terminal equipment UE-A is connected to the local communication network (not shown) of a residential or professional gateway GW, for example using a wired connection, for example of the Ethernet or wireless type, for example of the Wi-Fi type. Naturally, the development is not limited to this example and applies equally well to a cellular type mobile access network, to which the first item of terminal equipment UEA connects via a 2G to 5G type link.

It is assumed that the first item of terminal equipment UE-A, referred to as calling terminal, transmits a voice over IP call set-up request to a second item of terminal equipment UE-B of a user UTB, referred to as called terminal, which is also connected to the communication network RC. For example, terminals UE-A and UE-B are telephones of the smartphone type. Naturally, these can also be fixed-line telephones, for example of the DECT (Digital Enhanced Cordless Telecommunications) wireless type, tablets, personal computers, etc., and more generally any user terminals, provided they have an interface with the access network to the RC network available nearby and are configured to manage a voice over IP telephone communication via this network.

As illustrated in FIG. 1, the system 10 according to the development comprises, besides calling terminal UE-A and called terminal UE-B, an item of communication equipment EQ of the communication network RC. This item of communication equipment EQ is placed on the path of the call set-up request message transmitted by the calling terminal UE-A. This is, for example, a router, a telephone application server (TAS) or any other item of communication equipment of the network RC. According to the development, such an item of equipment EQ is configured to query at least one first data table, referred to as caller identity table IDB, managed by the communication network RC.

In the particular embodiment of FIG. 1, the item of equipment EQ comprises two separate items of equipment, connected to each other: an item of server equipment TAS and an item of equipment EIDS implementing a caller identification service IDS. In an operator network such as the network RC, it is common for an application server to communicate with various items of equipment dedicated to implementing specific services, such as the item of equipment EIDS. Such items of equipment have previously registered with the application server TAS so that it can retransmit certain call signalling messages. Naturally, the development is not limited to this example and also applies when the item of equipment EQ is the application server TAS itself and hosts several software applications each implementing a specific service and in particular the caller identification service IDS.

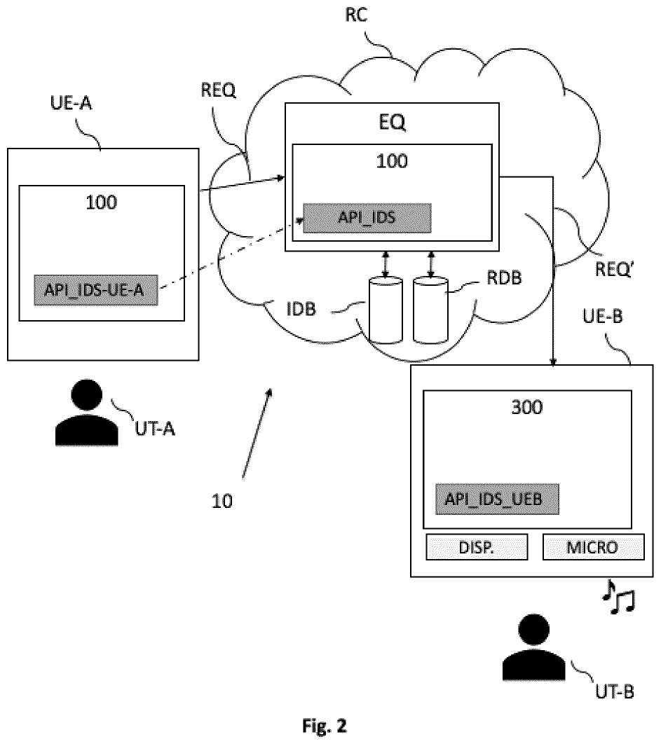

FIG. 2 shows an example of the architecture of the item of communication equipment EQ according to one embodiment of the development. According to this example, the item of communication equipment EQ comprises a device 100 for processing a call set-up request message according to the development. This device is configured to intercept said message, extract a telephone number of the caller, obtain additional caller identification information by querying the identity table IDB from said telephone number, update an information field of said message by inserting the information obtained and route the updated message to the called terminal.

Advantageously, the device 100 is configured to receive a request to record additional information in the identity table, in association with the caller's telephone number, check that the caller is authorised to record data in this table and send the caller a recording confirmation.

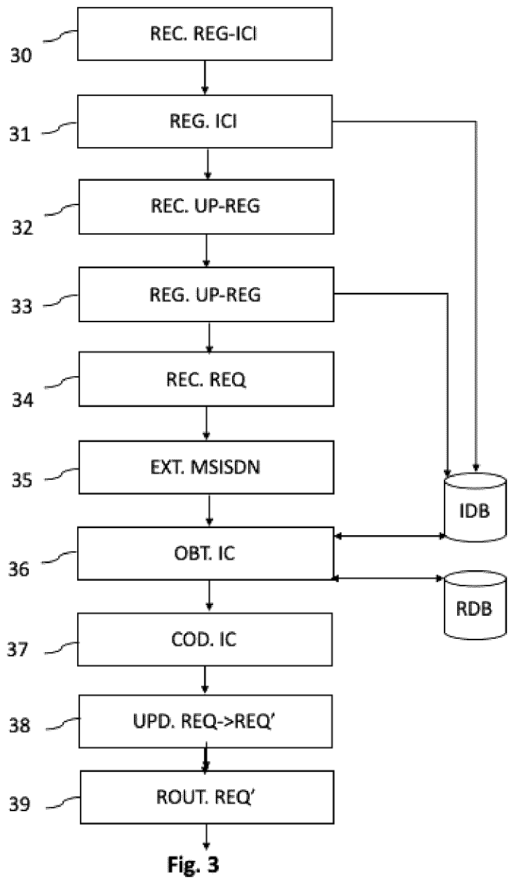

The device 100 thus implements the method for processing a call set-up request message according to the development that will be detailed hereafter in relation to FIG. 3. According to an embodiment, it is implemented in the form of an API-IDS software application of the API (Application Programming Interface) type, installed on the item of equipment EQ. Advantageously, this application is dedicated to the implementation of the caller identification service according to the development.

Alternatively, the device 100 may be independent of the item of equipment EQ, but connected to it by any link whatsoever, wired or not.

FIG. 2 also shows an example of the architecture of a user terminal UE-A, or calling terminal, according to an embodiment of the development. According to this example, the calling terminal UE-A comprises a device 200 for transmitting a call set-up request message transmitted by the terminal UE-A. According to the development, the called terminal UE-A is configured to, prior to transmission of said message, request a recording of additional caller identification information in a first data table, referred to as the caller identity table, stored in said communication network, in association with a caller telephone number, said additional caller identification information being intended to be used by an item of communication equipment configured to receive said call set-up request message, to enrich it at least using the information contained in said identity table and to retransmit it to the called terminal.

Advantageously, the device is also configured to request an update of the caller identity table, the update request comprising at least one additional item of information about the context of the call.

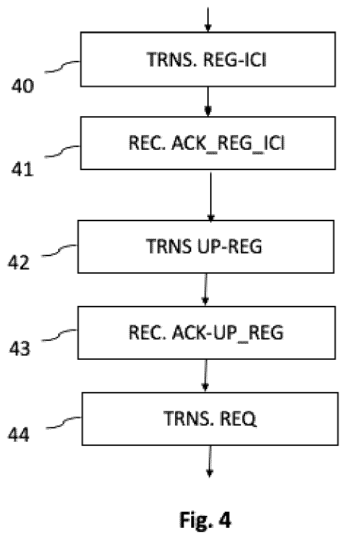

The device 200 thus implements the method for transmitting a call set-up request message according to the development that will be detailed hereafter in relation to FIG. 4.

According to one embodiment, it is implemented in the form of an API-IDS-UE-A software application of the API type, installed on the calling terminal UE-A. Advantageously, this application is dedicated to the use of the caller identification service by the calling terminal according to the development.

Finally, FIG. 2 shows an example of the architecture of a user terminal UE-B, or called terminal, according to an embodiment of the development. According to this example, the called terminal UE-B comprises a device 300 for receiving a call set-up request message transmitted by the terminal UEA. According to the development, the called terminal UE-B is configured to receive said message from the network, extract caller identification information from an information field of the message received, and trigger at least one action comprising a notification of said caller identification information to a user of the called terminal.

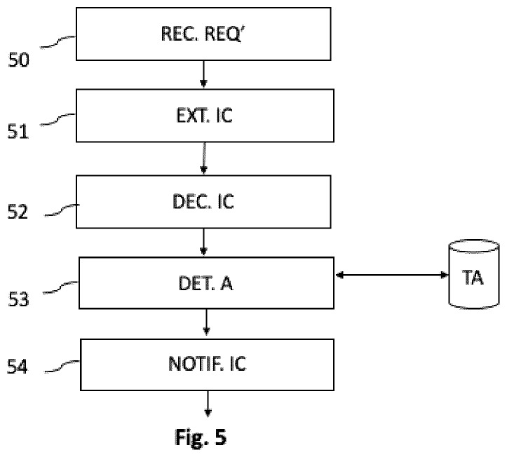

The device 200 thus implements the method for receiving a call set-up request message according to the development that will be detailed hereafter in relation to FIG. 5.

According to one embodiment, it is implemented in the form of an API-IDS-UE-B application of the API type, installed on the called terminal UE-B. Advantageously, this application is dedicated to the use of the caller identification service by the called terminal according to the development.

In relation to FIG. 3, an embodiment of a method for processing a call set-up request message according to one embodiment of the development is now presented in the form of a flowchart. This process is implemented by an item of communication equipment EQ configured to receive the call set-up request messages transmitted by the calling terminals. As mentioned above, it is implemented, for example, in the form of a software application API_IDS.

In an initialisation phase, prior to receiving a call set-up request message, the item of communication equipment EQ receives in 30 a request message REG_ICI to record caller identification additional information ICI from the terminal UE-A. In 31, the ICI information received is recorded in the identity table IDB in association with the telephone number of the terminal UE-A. Advantageously, this recording step is conditioned by a prior verification that the user UT-A of the terminal UE-A is authorised to record information in this table, because they have subscribed to the caller identification service of the operator of the network RC. For example, the user UT-A of the terminal UE-A has provided information about their identity to the operator who manages the identity table during a pre-registration phase, for example by filling in an online form. The identity information in question includes, for example, their name, telephone number, etc., and is stored in the identity table once it has been validated by this operator.

According to one embodiment, the communication equipment EQ receives in 32 from the terminal UE-A a request message REG-ICC to record additional information ICC relating to a call context. This context information ICC is linked to the telephone number of the called party and of the caller. Both telephone numbers are needed to find the specific information about the reason for the call for the called person, as it can vary from call to call and from person to person. For example, a sales marketer might call a first customer about repairing one of their appliances and a second customer to confirm an appointment. These calls from the same caller have different call reasons.

This information specifies the context of one or more forthcoming calls and includes, for example:
an item of information about a level of urgency of the call, for example when it comes from a deliverer or a health professional;
an item of information about a purpose or reason for the call, for example to tell the called party that their vehicle is ready for pick-up or to ask if they are available to talk on the phone.

In 33, the information ICC is recorded in association with the telephone number of the user UT-A and is added to the entry in the table IDB corresponding to the telephone number of the user UT-A. Naturally, this additional record may also be conditioned by a prior verification of the rights of the user UT-A, i.e. that they have indeed subscribed to the caller identification service.

Such a request to register information ICC can be received and processed at any time by the item of communication equipment EQ. It is used to adapt the contents of the identity table dynamically to the needs of the user of the calling terminal UE-A.

In 34, the item of equipment EQ receives a request message REQ to set up a call to the called terminal UE-B.

In the following, it is considered as an example that the call signalling messages exchanged between the calling and called terminals and the communication network RC comply with the SIP communication protocol.

It is therefore assumed that the call set-up request message REQ is of the SIP INVITE type. This SIP INVITE message includes information about the calling party UT-A and the called party UT-B and initiates the information exchange process between the two terminals to establish the voice communication (supported codecs, etc.). The SIP INVITE message generally comprises several headers intended to specify technical information relating to the calling terminal, to the codecs to be used to decode the audio streams, routing information, etc. It includes at least one header relating to the identities of the parties (“From and P-Asserted Identity (PAI)”) that serve to carry the logic addresses of the parties, such as the telephone number or MSISDN (Mobile Station International Subscriber Directory Number) or the VoIP address of the calling terminal UE-A and the telephone number or VoIP address of the called party. This latter header also includes an information field for the caller's name (“DisplayName”). However, it should be noted that this field is rarely used for voice calls, as the telephone number assigned in the “From and P-Asserted Identity (PAI)” header of the caller is sufficient to validate the caller's identity and initiate the call presentation to the called party.

The SIP INVITE message is routed in the operator's communication network RC by means of several items of communication equipment such as routing equipment, session controller equipment and telephony application servers (TAS). In particular, such an application server is configured to retransmit the SIP INVITE messages passing through it and relays, to communication equipment or software applications configured to render dedicated services related to the processing of a telephone communication. These items of communication equipment and software applications were previously registered with the TAS application server. They include, for example, billing and proxy services. A proxy is a server that acts as an intermediary and whose main purpose is to hide network details from external connections in order to maintain its security. The proxy transmits requests to sensitive areas of the network without sharing any details of the network, such as the IP address. The software applications in question may be hosted by the application server itself or by a separate item of communication equipment EQ.

In the following, an item of communication equipment EQ configured to implement a caller identification service according to the development is considered in particular. It implements the method for processing a call set-up request message according to the development or incorporates a processing device 100 according to the development which has just been presented in relation to FIG. 2.

In 34, it receives the call set-up request message REQ transmitted by the calling terminal UE-A.

In 35, it extracts the caller's telephone number from a header of said message REQ, for example the “From and P-Asserted Identity (PAI)” header.

In 36, it queries the local or remote IDB identity table managed by the operator, for example using the extracted telephone number as an index, in order to obtain additional identity information ICI about the caller. This table comprises records, each associating with a telephone number of a subscribing user of the communication network RC operator, one or more additional items of information ICI about their identity.

It thus obtains, for example:
an item of information relating to the caller's identity, such as their name or the name of the company, when the caller is a professional;
an item of information relating to an image or video associated with the caller, for example a company logo, a photograph of the caller or an advertising video presenting the company.

By nature, this additional information is relatively permanent. Advantageously, it has been recorded in the table IDB at the caller's request, in an initial and prior phase, generally following their subscription to the caller identification service offered by the operator.

According to a particular embodiment of the development, the table IDB can also include additional information ICC relating to a call context for one or more calls that the caller envisages making. The item of communication equipment EQ therefore obtains, for example:
an item of information about a level of urgency of the call, for example when it comes from a deliverer or a health professional;
an item of information about a purpose or reason for the call, for example to indicate that their vehicle is ready for pick-up or to ask if they are available to talk on the phone.

By nature, this additional information relating to the call ICC is likely to change depending on the caller's intentions. Advantageously, it is recorded in the table IDB at the caller's request, just before making one or more calls.

If the caller's telephone number is not stored in the identity table IDB, the obtained answer is empty and contains no additional information.

According to a particular embodiment, the method comprises obtaining reputation information of the caller UE-A from a second data table, referred to as reputation table RDB, comprising entries associating reputation information, such as a type of caller, with a caller's telephone number. A type of caller includes a commercial type, which refers to sales marketers, a fraudulent type and a legitimate type. This reputation table RDB is updated by the operator progressively, in a manner known per se.

Reputation information can be obtained in different ways by the operator of the communication network. According to a first embodiment, the latter uses reports sent by users who have already received calls from this caller to indicate that the caller is a telemarketing company, for example. According to a second embodiment, the operator can analyse call records to identify sales or fraudulent marketers on the basis of predetermined call patterns. For example, a sales marketer typically makes many calls to many different people over a short period of time. A fraudulent caller seeks to incite the called party to call back on a premium rate telephone number by making numerous short calls and hanging up before the called party can answer (“ping calls”).

When the caller's telephone number is stored in the identity table IDB, the obtained response includes at least one item of additional identification information ICI, such as the name of the user UT-A “UT-A-name” and optionally, an additional item of call context information ICC.

At the end of this step 36, it is assumed that the item of communication equipment EQ has obtained additional information IC, which include additional caller identification information ICI and/or additional call context information ICC and/or reputation information IR about the calling user UT-A.

This additional information IC contained in the answer of the identity table is then inserted in 38 in an information field of a header of the call set-up request message REQ received, for example, according to the SIP protocol, the “DisplayName” field of the “From and P-Asserted Identity” header. The modified message REQ is then referred to as REQ′.

Finally, the call set-up request REQ′ thus completed or updated is sent in 39 to its final destination, i.e. the called terminal UE-B.

Optionally, some additional information about the caller's identity is pre-coded in 38 before being inserted in the call set-up request message REQ′. This includes additional information other than the caller's name.

For example, it is coded using a code comprising a sequence of text-type characters corresponding to the additional information IC to be transmitted, surrounded by two occurrences of a key-type character, said key-type character being associated with a particular type of information.

For example, the key character is an asterisk (*) associated with the type of caller, such as *TELE * for a sales marketer. Optionally, the development also provides for a key character to be associated with the name of the caller, such as “′” or “″”.

In relation to FIG. 4, an implementation of a method for receiving by a called terminal of a voice over IP call set-up request message transmitted by a calling terminal in a communication network, according to one embodiment of the development.

In 40, the calling terminal UE-A, prior to transmitting a call, transmits in the communication network IC a request REG-ICI to record additional calling user UT-A identification information in the identity table IDB. This table is stored in and managed by said communication network.

Advantageously, the method comprises a step of receiving in 41 a registration confirmation message ACK_REG-ICI of said information in the identity table IDB, from the item of communication equipment EQ.

According to one embodiment of the development, the terminal UE-A transmits in 42 an identity table IDB update request UP-REG, said update request comprising at least one additional item of information ICC about the context of the call, which specifies for example a purpose of the call, a level of urgency, an emotion of the caller, etc.

Advantageously, it receives in 43 a message confirming the recording ACK_UP-REG of said information in the identity table IDB, from the item of communication equipment EQ.

One advantage is to enable the dynamic update of the identity table managed by the communication network by the caller before one or more next messages are transmitted to one or more called terminals using information specific to the context of these calls.

In relation to FIG. 5, an implementation of a method for receiving by a called terminal of a voice over IP call set-up request message transmitted by a calling terminal in a communication network, according to one embodiment of the development, is now presented in the form of a flowchart.

According to this embodiment, the called terminal UE-B includes the device 200. For example, the receiving method according to the development is implemented by the device 200 in the form of a software application API_IDS_UEB.

In 50, the called terminal UE-B receives a call set-up request message, for example of the SIP INVITE type, from the calling terminal UE-A. It is assumed that it is the message REQ′ enhanced by the item of communication equipment EQ in accordance with the processing method just described in relation to FIG. 4.

Upon reception of said message, it extracts in 51 one or more additional items of information IC about the caller's identity from an information field of the received message, for example from the “DisplayName” field of the “From and P-Asserted Identity” header.

Advantageously, this information IC can include:
one or more additional items of caller identification information ICI, and/or
one or more additional items of call information ICC to a calling terminal, and/or
one or more items of caller reputation information IR.

According to one embodiment of the development, at least some items of the information extracted from the call set-up request message are encoded using a code comprising a sequence of textual information surrounded by two occurrences of a key-type character. In this case, the method comprises in 52 the decoding of the extracted information. Such a decoding comprises identifying said key type character and obtaining at least one type of information associated with the identified key character.

For example, for an additional item of caller identification information ICI, of the link to a downloadable image or video file type, the key character used is “%”.

For example, for an additional item of call context information ICC, the key character “!” can be used to surround the caller's name and indicate an urgent call. According to yet another example, the key character “?” can be used to surround the caller's name and is meant to ask the called party if they are available to talk, or to indicate a purpose of the call, for example (“Attempt to access your account” or “Your vehicle is ready to be picked up”).

For example, for an item of reputation information IR, the key character “*” is used to surround a sequence of textual characters qualifying a type of caller (SPAM for fraudulent, TELE for a sales marketer or OK for a legitimate caller).

In 53, at least one notification action for the extracted information is determined depending on the key character identified. According to one embodiment of the development, the determination comprises consulting an action table TA stored in memory, said table comprising entries associating one or more notification actions with a key character. For example, the key character “!” used to indicate the urgency of the call is associated with the emitting of a specific ringtone, with a pressing pattern, or with the display of the text sequence in flashing red, or with the display of an “URGENT” banner next to the text sequence.

According to another example, the key character “%” used to surround a link to an associated image or video is associated with the action of fetching the file from the indicated link and displaying it on the screen of the called terminal.

According to yet another example, the key character “*” used to indicate a type of caller or a type of call is associated with the display of a window, for example of the “pop-up” type, including the type of caller received in the textual sequence.

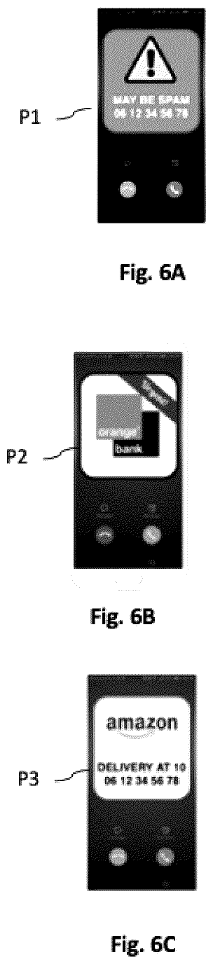

Advantageously, the action triggered is also adapted to the value of the extracted textual sequence. To illustrate this adaptation, examples of notifications are shown in FIGS. 6A to 6C. In relation to FIG. 6A, a window P1 is displayed on the screen of the called terminal UE-B to notify the user of a fraudulent call, following reception of the additional item of information *SPAM*. It includes, for example, a warning or danger sign or icon. In relation to FIG. 6B, a window P2 is displayed on the screen of the called terminal UE-B to notify the user of an urgent call from a banking organisation, following the reception of the additional item of information !ORANGE BANK !. It includes, for example, a red banner indicating the urgency of the call. In relation to FIG. 6C, a window P3 is displayed on the screen of the called terminal UE-B to notify the user of an urgent call relating to a delivery, following the reception of the additional information !company name+deliverer! and %company_logo_link%.

In 54, the notification action(s) of the additional information about the caller's identity is(are) triggered when the call is presented to the caller on their terminal UE-B.

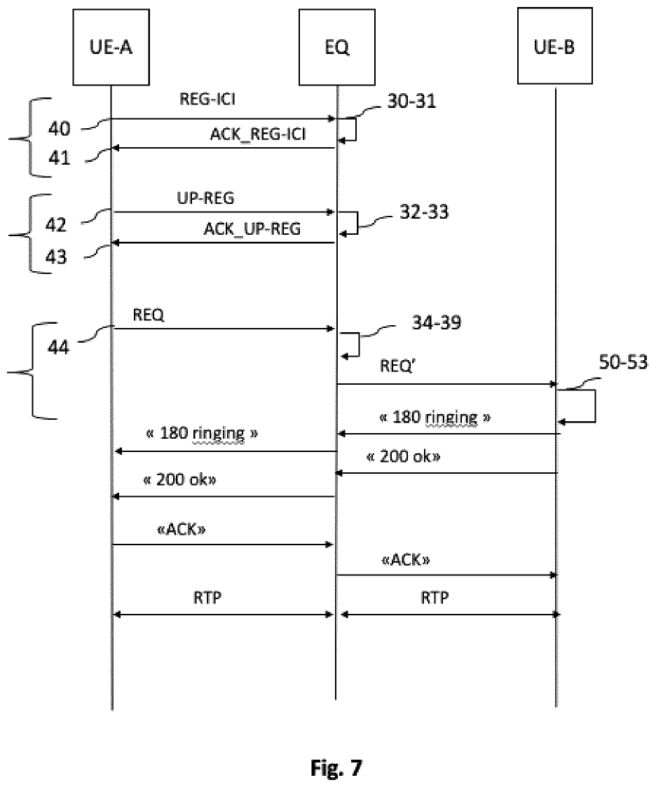

In relation to FIG. 7, the exchanges of signalling messages between the calling terminal UE-A, the item of communication equipment EQ and the called terminal UE-B according to one embodiment of the development are now presented in the form of a flow diagram.

It is assumed that the user UT-A of the terminal UE-A has previously subscribed to the caller identification service offered by the operator of the communication network RC. In an initialisation phase, in 40, it sends a registration request REG-ICI for additional identification information from the user UT-A. Upon reception, the item of communication equipment EQ records in 31 the information received in the identity table IDB and sends an acknowledgement message ACK_REG-ICI to the terminal UE-A. It is received by the terminal UE-A in 41.

Optionally, in 42, the terminal UE-A sends an additional information ICI update request UP-REG. It includes, for example, context information ICC of a call to a called terminal, which specifies, for example, a level of urgency of the call or a purpose of this call or an emotion of the caller UT-A associated with this call. This information is therefore associated both with the telephone number of the caller UE-A and with a telephone number of a terminal UE-B that the user UT-A of the calling terminal UE-A wishes to call.

It is received in 32 by the item of communication equipment EQ, which registers it in 33 and answers with an acknowledgement message ACK_UP-REG. It is received in 43 by the terminal UE-A.

In the following, it is considered that an exchange of signalling messages that comply with the SIP protocol, for example described in document RFC 3261 by Rosenberg et al, published by The Internet Society in June 2002. As these messages are known to those skilled in the art, details of their format are not described below.

In 44, the terminal UE-A transmits a call set-up request message REQ, for example of the SIP INVITE type, to the called terminal UE-B.

The item of communication equipment EQ is configured to intercept the call signalling messages exchanged between the calling terminal UE-A and the called terminal UE-B. More specifically, it ignores all messages and relays them unchanged to the receiving party, except the message REQ. Upon reception of the message REQ in 34, the item of communication equipment EQ implements the processing method according to the development which has just been described in relation to FIG. 3. It extracts in 35 the caller's telephone number, queries in 36 at least the identity table IDB from this telephone number to obtain additional information IC to add to the call set-up request. From the identity table IDB, it obtains additional caller identification information ICI and/or call context information ICC.

For example, it obtains the following answer to its request to query the identity table IDB:
Name: Orange
Logo: orange.com/assets/logo.png
Purpose: Attempted Access To Your Account
Urgency: High
AppName: None
Qualification: Validated
RequestToTalk: <yes>

Additional information ICI include the name of the caller, which is the Orange company and a link to its logo.

The call context information to the called party UE-B includes a high level of urgency, a purpose (“Attempting to access your account”) and a caller request (“Are you available to talk?”).

The “AppName” information field can specify the name of an application that will be launched when the user answers the call. The qualification field indicates that the caller's name and telephone number have been validated by the operator managing the identity table of a caller.

Optionally, it also consults a reputation table RDB, from which it obtains the caller's reputation information IR. For example, it does this when it has not found any record in the identity table IDB that matches the caller's telephone number.

In 37, the item of communication equipment EQ decodes the obtained information, updates in 38 the call set-up request message with the decoded information and retransmits in 39 the updated message REQ′ to the called terminal UE-B.

As a result, the message REQ′ is enriched with additional information relating to the identity of the calling user UT-A and/or to a context of the call, which is transmitted, for example, in the “DisplayName” field of the “From and P-Asserted Identity” header of said message.

In this way, the item of communication equipment EQ, by implementing the development, provides an intermediate service, referred to as the caller identity service, which is implemented, for example, in the form of a dedicated software application.

Upon reception of this message REQ′ in 50 by the called terminal UE-B, the latter answers by sending back into the communication network RC a signalling message, for example of the 100 “TRYING” type, to indicate that it has received the call set-up request message and that it is not necessary to send other messages.

The called terminal UE-B then implements the receiving method according to the development which has just been presented in relation to FIG. 5. For example, the additional information IC inserted by the item of communication equipment EQ is extracted in 51, decoded in 52 and translated in 53 into notification actions to be triggered when the call is presented to the user UT-B in 54. The called terminal UE-B then presents the call to the user UT-B by triggering the A notification action(s) of the additional information about the caller's identity.

For example, the receiving method according to the development is implemented in the form of a dedicated software application, which was previously loaded into the called terminal UE-B.

Once the call has been presented to the user, the called terminal UE-B sends to the calling terminal UE-A a message of the SIP 180 “RING” type to inform it that the user UT-B has been alerted.

In a manner known per se, these signalling messages can also contain additional information, added by the called terminal UE-B, for example relating to the codecs available on the called telephone, or to its ability to play media streams referred to as early, such as a free message played during the interval preceding the transmission of a call to the voice mail.

The calling terminal UE-A receives the SIP 180 message “RINGING”.

If the called user UT-B accepts the call, the called terminal UE-B sends a 200 OK signalling message in the communication network RC. It is retransmitted to the calling terminal UE-A, which answers it with an acknowledgement message, for example of the 200 “OK” type. The acknowledgement message is retransmitted to the called terminal UE-B. At this stage, the communication between the parties is established and the data traffic, for example in accordance with the RTP (Real Time Protocol) communication protocol, which contains the audio or video media streams of the communication between the two terminals, begins to be transmitted.

For example, the coded information inserted in the “DisplayName” information field is as follows:
DisplayName=!?Orange?!%orange.com/assets/logo.png% Attempted Access To Your Account

The caller is the Orange company. This is an urgent call, because the name Orange is surrounded by the key character “!”. A link to the Orange logo is provided. The purpose of the call is to alert the called party about an attempt to access their account, as indicated by the key character “?”.

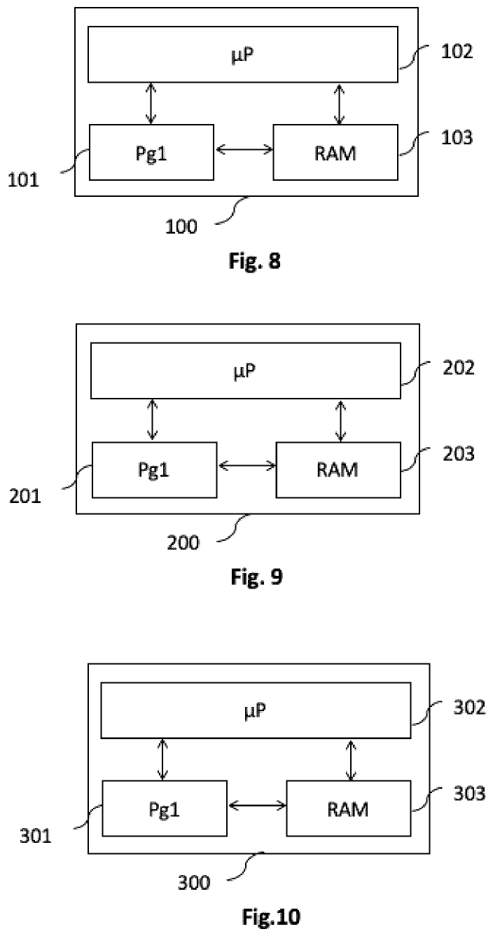

An example of material structure of a device 100 for processing a call set-up request message in a local communication network according to the development, comprising at least one module for receiving said message, a module for extracting a telephone number of the caller from said message, a module for updating an information field of said message by inserting additional caller identification information obtained from a first data table, referred to as caller identity table, and a module for sending the updated message to the called terminal is now presented in relation to FIG. 8.

Advantageously, the device 100 also comprises a module for verifying the rights of the user of the calling terminal, a module and the module for updating is configured to insert into the call set-up request message caller reputation information obtained from a second data table, referred to as reputation table.

Advantageously, it also comprises a module for receiving a request to add information associated with the telephone number of a caller from a calling terminal, said request comprising said telephone number and information relating to a content of a next call, and a module for adding said information relating to a content of a next call to the additional identification information associated with said telephone number.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (a RAM memory, for example), a processing unit 102 equipped for example with a processor and controlled by a computer program Pg, representative of the modules for receiving, retrieving, querying, updating and routing, stored in a read-only memory 101 (a ROM memory or hard disk, for example). At initialisation, the code instructions of the computer program are for example loaded into a random access memory 103 before being executed by the processor of the processing unit 102. The random access memory 103 can also contain a data table comprising an entry associating access rights to the caller identification service with the caller's telephone number. It can also contain a copy of the information IC extracted from the identity table and/or the reputation table RDB from the caller's telephone number.

FIG. 8 only shows a particular one of several possible ways of implementing the device 100, so that it executes the steps of the method for processing a voice over IP call set-up request message in a communication network as detailed above, in relation to FIGS. 3 and 7 in its different embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In which case the device 100 is implemented with a reprogrammable computing machine, the corresponding program (i.e. the sequence of instructions) can be stored in a removable (such as, for example, an SD card, a USB flash drive, a CD-ROM or DVD-ROM) or non-removable storage medium, this storage medium being partially or totally readable by a computer or a processor.

The different modes of implementation have been described above in relation to a device 100 included into an item of communication equipment EQ, but it can also be separate from this item of equipment and connected to it by a wired or wireless interface.

An example of the material structure of a device 200 for transmitting a call set-up request message transmitted by a calling terminal to a called terminal in a communication network according to the development, comprising at least a module for transmitting a request to record additional caller identification information in the identity table IDB, stored in said communication network, in association with a caller telephone number, a module for receiving a recording confirmation and a module for transmitting the call set-up request message is now presented in relation with the FIG. 9.

Advantageously, the device 200 also comprises a module for transmitting to the communication network a request to update the caller identity table, said update request comprising at least one item of call context information.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (a RAM memory, for example), a processing unit 202 equipped for example with a processor and controlled by a computer program Pg2, representative of the reception, activation, connection, verification, selection, obtaining, wake-up and execution modules, stored in a read-only memory 201 (a ROM memory or hard disk, for example). At initialisation, the code instructions of the computer program are for example loaded into a random access memory 203 before being executed by the processor of the processing unit 202. The random access memory 203 can also contain the additional information that the user of the calling terminal requests to record in the identity table of the communication network.

FIG. 9 only shows a particular one of several possible ways of implementing the device 200, so that it executes the steps of the method for transmitting a call set-up request message as detailed above, in relation to FIGS. 4 and 7 in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (i.e. the sequence of instructions) can be stored in a removable (such as, for example, an SD card, a USB flash drive, a CD-ROM or DVD-ROM) or non-removable storage medium, this storage medium being partially or totally readable by a computer or a processor.

Finally, in relation to FIG. 10, an example of material structure of a device 300 for receiving by a called terminal of a call set-up request message transmitted by a calling terminal in a communication network according to the development is presented, comprising at least one module for receiving said message, a module for extracting additional information relating to the caller from an information field of the received message and a module for triggering at least one action comprising a notification of said information to a user of the called terminal.

Advantageously, the device 300 also comprises a module for decoding said information, said decoding comprising the identification of said key-type character and a module for determining a notification action to be triggered at least depending on the identified key-type character.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 300 comprises a random access memory 303 (a RAM memory, for example), a processing unit 302 equipped for example with a processor and controlled by a computer program Pg, representative of the modules for receiving, extracting, decoding, determining and triggering, stored in a read-only memory 301 (a ROM memory or hard disk, for example). At initialisation, the code instructions of the computer program are for example loaded into a random access memory 303 before being executed by the processor of the processing unit 302. The random access memory 303 may also contain a table comprising an entry associating a key character with one or more actions to be triggered when the call is presented.

FIG. 10 only shows a particular one of several possible ways of implementing the device 300, so that it executes the steps of the method for receiving a call set-up request message as detailed above, in relation to FIGS. 5, 6 and 7 in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In which case the device 300 is implemented with a reprogrammable computing machine, the corresponding program (i.e. the sequence of instructions) can be stored in a removable (such as, for example, an SD card, a USB flash drive, a CD-ROM or DVD-ROM) or non-removable storage medium, this storage medium being partially or totally readable by a computer or a processor.

The development that has just been described in its different embodiments has many advantages. By enriching the call presented to the called terminal with caller identification information, that is managed and validated, and therefore trustworthy, by the communication network, it helps to increase the call acceptance rate by the called terminals. In addition, because the call enrichment is carried out in the communication network, it does not introduce any latency at the called terminal before the call is presented to the user. According to the development, this enrichment is based on information stored in a single table managed by the network operator and is therefore transmitted in a single data format, which simplifies its interpretation and use by the called terminals. Finally, the development does not involve any change to the syntax of the call signalling messages, since the additional information is advantageously transmitted in an information field of the call set-up message which is already stipulated by the standard, but had not yet been used in practice.

1. A processing method of a call set-up request message transmitted by a calling terminal to a called terminal in a communication network, the network comprising an item of communication equipment configured to receive the message, wherein the method is implemented at the item of communication equipment and comprises:
updating an information field of the message by inserting additional caller identification information obtained from at least one first data table; and
transmitting the updated message to the called terminal.

2. The processing method according to claim 1, wherein, when no additional information is obtained from the first table, the update comprises insertion of reputation information obtained from a second data table, into the call set-up request message.

3. The processing method according to claim 1, wherein the method further comprises:
receiving a request to add additional information associated with the caller's telephone number from the calling terminal, the request comprising the telephone number and the information; and
storing the information in the first table in association with the telephone number.

4. The processing method according to claim 1, wherein the method comprises coding of at least one of the items of information obtained in the form of a code comprising a sequence of text-type characters surrounded by two occurrences of a key-type character, the key-type character being associated with a predetermined item of call context information.

5. A transmission method of a call set-up request message by a calling terminal to a called terminal in a communication network, wherein the method is implemented at the calling terminal and comprises, prior to transmitting the message:
transmitting a request to record additional caller identification information in a first data table stored in the communication network, in association with a caller telephone number, the additional caller identification information being intended to be used by an item of communication equipment configured to receive the call set-up request message, to enrich it at least using the information contained in the first table and to retransmit it to the called terminal.

6. The transmission method according to claim 5, wherein the method also comprises transmission to the communication network of a request to update the first table, the update request comprising at least one item of context information of the call.

7. A receiving method of a call set-up request message by a called terminal transmitted by a calling terminal in a communication network, wherein the method is implemented at the called terminal and comprises, upon reception of the message:
extracting additional information relating to a user of the calling terminal from an information field of the received message; and
triggering at least one action comprising a notification of the information to a user of the called terminal when the call is presented.

8. The receiving method according to claim 7, wherein at least one of the additional items of information relating to the call is encoded in the form of a sequence of text-type characters surrounded by two occurrences of a key-type character, in that the method comprises decoding of the item of information, the decoding comprising identification of the key-type character and in that the method comprises determination of at least one notification action triggered at least depending on the identified key-type character.

9. A device for processing a call set-up request message transmitted by a calling terminal to a called terminal in a communication network, the network comprising an item of communication equipment configured to receive the message, wherein the device is configured to implement at the item of communication equipment:
updating an information field of the message by inserting additional caller identification information obtained from at least a first table; and
transmitting the updated message to the called terminal.

10. A device for transmitting a call set-up request message by a calling terminal to a called terminal in a communication network, wherein the device is configured to implement at the calling terminal, prior to transmitting the message:
transmitting a request to record additional caller identification information in a first data table, stored in the communication network, in association with a caller telephone number, the additional caller identification information being intended to be used by an item of communication equipment configured to receive the call set-up request message, to enrich it at least using the information contained in the first table and to retransmit it to the called terminal.

11. A device for receiving a call set-up request message by a called terminal transmitted by a calling terminal in a communication network, wherein the device is configured to implement at the called terminal and comprises, upon reception of the message:
extracting additional information (IC) relating to a user (UT-A) of the calling terminal (UE-A) from an information field of the received message; and
triggering at least one action comprising a notification of the information to a user of the called terminal when the call is presented.

12. A data table of a communication network, wherein the data table comprises records associating at least additional identification information of a caller with a telephone number of this caller.

13. A system for managing a voice over IP call set-up request message transmitted by a calling terminal to a called terminal in a communication network, wherein the system comprises a processing device for processing a call set-up request message transmitted by a calling terminal to a called terminal in a communication network comprising an item of communication equipment configured to receive the message, a transmission device for transmitting a call set-up request message by a calling terminal to a called terminal in a communication network, a receiving device for receiving a call set-up request message by a called terminal transmitted by a calling terminal in a communication network and a data table according to claim 12,
the processing device being configured to implement at the item of communication equipment:
updating an information field of the message by inserting additional caller identification information obtained from at least a first table; and
transmitting the updated message to the called terminal;
the transmission device being configured to implement at the calling terminal, prior to transmitting the message:
transmitting a request to record additional caller identification information in a first data table, stored in the communication network, in association with a caller telephone number, the additional caller identification information being intended to be used by an item of communication equipment configured to receive the call set-up request message, to enrich it at least using the information contained in the first table and to retransmit it to the called terminal;
the receiving device being configured to implement at the called terminal and comprising, upon reception of the message:
extracting additional information relating to a user of the calling terminal from an information field of the received message; and
triggering at least one action comprising a notification of the information to a user of the called terminal when the call is presented.

14. A processing circuit comprising a processor and a memory, the memory storing program code instructions of a computer program for implementing the method according to claim 1, when the computer program is executed by the processor.
